(19) United States
(12) Patent Application Publication
(10) Pub. No.: US 2007/0223667 A1
(43) Pub. Date: Sep. 27, 2007

(54) Service request apparatus and service request process method

(75) Inventor: Koichi Mitsuhori, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/492,003

(22) Filed: Jul. 25, 2006

(30) Foreign Application Priority Data
Mar. 27, 2006 (JP) 2006-086528

(51) Int. Cl. H04M 3/42

(52) U.S. Cl. 379/201.01

(57) ABSTRACT

A service request apparatus that is connected to a service providing apparatus is disclosed. The service request apparatus includes: a failure state storing unit configured to store a failure state of the service providing apparatus; and a service request determination unit configured to refer to the failure state storing unit so as to determine not to send a service request to the service providing apparatus when the service providing apparatus is in failure.

### BACKGROUND OF THE INVENTION

1. Field of the Invention

The present invention relates to a service request apparatus and a service request process method. More particularly, the present invention relates to a service request apparatus connected to a service providing apparatus, and to a service request process method performed by the service request apparatus for processing a service request to be sent to the service providing apparatus.

2. Description of the Related Art

In a communication system in which functions are distributed among a plurality of service providing apparatuses, when even a part of the functions breaks down, the whole functions of the communication system may stop.

FIG. 1 shows an example of a communication system in which a part of the functions of the communication system affects the whole communication system. The communication system shown in FIG. 1 includes a service request apparatus and service providing apparatuses “a”-“c”. The service request apparatus sends a request signal for requesting the service providing apparatus “a” to perform a service component “a”, and receives a response signal when the service component “a” is realized in the service providing apparatus “a”. The service components “b” and “c” are processed similarly. As a result, a service can be provided in the communication system as a whole.

However, for example, when the response signal is not received from the service providing apparatus “b” due to failure of the service apparatus “b”, the service request apparatus cannot provide the service. According to circumstances, a communication line between the service request apparatus and the service providing apparatus “b” may be congested by sending the request signal to the service providing apparatus “b” repeatedly.

A communication system disclosed in Japanese Laid-Open Patent Application No. 2005-80157 (to be referred to as patent document 1) is a concrete example of the above-mentioned communication system. FIG. 2 shows the communication system of the patent document 1. The communication system of FIG. 2 includes a SIP (Session Initiation Protocol) server 1, an access point manager 3, access points 5a and 5b, and wireless terminals 7a and 7b. The SIP server 1 controls VoIP (Voice over Internet Protocol) communications based on SIP protocol. The access point manager 3 receives terminal registration of the wireless terminal from the access point. In addition, the access point manager 3 sends a request for bandwidth allocation from the SIP server 1 to the access point. Each of the access points 5a and 5b deals with voice packets of the VoIP communication preferentially based on the request for bandwidth allocation from the access point manager.

In this communication system, when the wireless terminal 7a performs VoIP communications with the wireless terminal 7b based on the SIP protocol, the following procedure is carried out. When the wireless terminal 7a sends a connection request to the SIP server via the access point 5a in step 1, the SIP server 1 sends the request for bandwidth allocation to the access point manager 3 in step 3. The access point manager 3 sends the request for bandwidth allocation to the access points 5a and 5b that are an origination side and a destination side respectively in step 5, so that the access points 5a and 5b allocates bandwidth. As a result, VoIP communications from the wireless terminal 7a to the wireless terminal 7b can be performed.

On the other hand, Japanese Laid-Open Patent application No. 6-35718 (to be referred to as patent document 2) discloses a system degeneracy scheme for detaching a failed task when a system is out of order.

In the communication system disclosed in the patent document 1, when the function of the access point manager 3 stops, the following phenomenon occurs. Although the SIP server 1 continues to send the request for bandwidth allocation to the access point manager 3, there is no response from the access point manager 3. Therefore, the VoIP communication from the wireless terminal 7a to the wireless terminal 7b cannot be established. In addition, as a result that the SIP server 1 continues to send the request to the access point manager 3, the network may be congested.

It is difficult to apply the system degeneracy scheme of the patent document 2, for example, to the communication system in the patent document 1 for solving the above-mentioned problems.

Accordingly, there is a possibility that a partial function outage of the communication system affects the whole communication system.

For example, in a highly public online processing system (online system of a bank, a telephone exchange system, and the like), measures are taken against failures by adopting system redundancy to prevent the whole system to be stopped. However, there is a drawback in the redundancy of the system since expensive servers need to be provided redundantly. In addition, even though the system is made redundant, double failures may occur, and when the double failures occur, the whole system stops.

Therefore, the partial function stop of the communication system may affect the whole communication system, and especially, it has a profound effect to the highly public communication system.

### SUMMARY OF THE INVENTION

The present invention is contrived in view of the above-mentioned problems, and an object of the present invention is to continue to provide a service of a communication system even when a service providing function of a part of the communication system stops.

The object of the present invention can be achieved by a service request apparatus that is connected to a service providing apparatus, including:

a failure state storing unit configured to store a failure state of the service providing apparatus; and

a service request determination unit configured to refer to the failure state storing unit so as to determine not to send a service request to the service providing apparatus when the service providing apparatus is in failure.

The object of the present invention can be also achieved by a service request apparatus that is connected to a service providing apparatus, including:

a service request unit configured to send a service request to the service providing apparatus; and

a service response setting unit configured to set a response for the service request in place of the service providing apparatus when there is no response for the service request.

The object of the present invention can be also achieved by a service request process method performed in a service request apparatus that is connected to a service providing apparatus, including the steps of:

storing a failure state of the service providing apparatus in the failure state storing unit; and

referring to the failure state storing unit so as to determine not to send a service request to the service providing apparatus when the service providing apparatus is in failure.

The object of the present invention can be also achieved by a method performed in a service request apparatus that is connected to a service providing apparatus, including the steps of:

sending a service request to the service providing apparatus; and

setting a response for the service request in place of the service providing apparatus when there is no response for the service request.

According to the present invention, even when a service providing function of a part of the communication system stops, other services of the communication system can continue to be provided.

### BRIEF DESCRIPTION OF THE DRAWINGS

Other objects, features and advantages of the present invention will become more apparent from the following detailed description when read in conjunction with the accompanying drawings, in which:

FIG. 1 is an overall view of a system providing a service using a plurality of service providing apparatuses;

FIG. 2 is an overall view of a communication system providing VoIP communications;

FIG. 3 is a block diagram showing a system of the first embodiment of the present invention;

FIG. 4 is a block diagram showing a system of the second embodiment of the present invention;

FIG. 5 is a block diagram showing a system of the third embodiment of the present invention;

FIG. 6 is a block diagram showing a SIP server and an access point manager to which the embodiment of the present invention is applied;

FIG. 7 is a flowchart showing communication connection operation in the SIP server to which the embodiment of the present invention is applied;

FIG. 8 is a flowchart showing failure state monitoring operation in the SIP server using the embodiment of the present invention;

FIG. 9 is a block diagram of a SIP server, an access point manager and an access point to which the embodiment of the present invention is applied;

FIG. 10 is a flowchart showing bandwidth allocation management operation in the access point manager to which the embodiment of the present invention is applied;

FIG. 11 is a flowchart showing failure state monitoring operation in the access point to which the embodiment of the present invention is applied;

FIG. 12 is a block diagram of an access point and an access point manager to which the embodiment of the present invention is applied;

FIG. 13 is a flowchart showing terminal registration operation in the access point to which the embodiment of the present invention is applied;

FIG. 14 is a flowchart showing failure state monitoring operation in the access point to which the embodiment of the present invention is applied.

### DETAILED DESCRIPTION OF THE PREFERRED EMBODIMENTS

In the following, embodiments of the present invention is described with reference to figures.

### First Embodiment

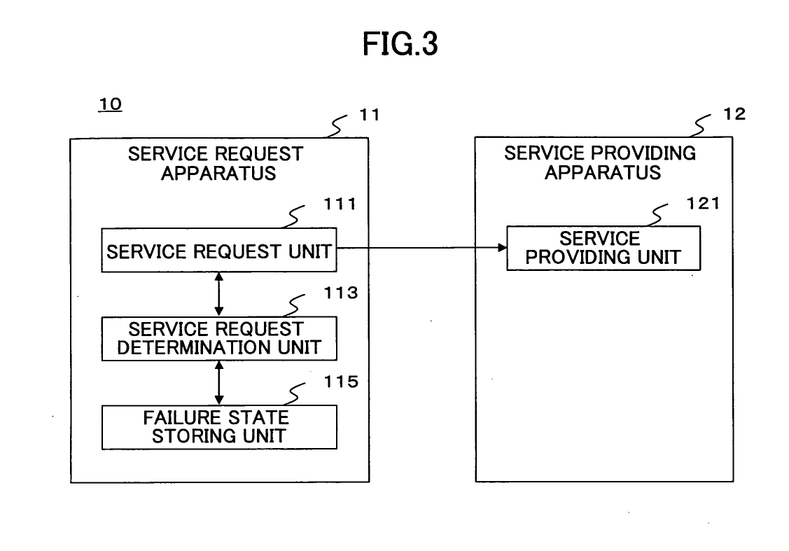

FIG. 3 is a block diagram showing the whole of a system 10 of the first embodiment of the present invention.

The system 10 includes a service request apparatus 11 and a service providing apparatus 12.

The service request apparatus 11 includes a service request unit 111, a service request determination unit 113, and a failure state storing unit 115. The failure state storing unit 115 stores a failure state of the service proving apparatus 12. The service request determination unit 113 determines whether the service providing apparatus 12 is in failure by referring to the failure state storing unit 115. When the service providing apparatus 12 is determined to be in failure, the service request determination unit 113 instructs the service request unit 111 not to send a service request to the service providing apparatus 12. When the service request determination unit 113 determines not to send the service request, the service request unit 111 does not send a service request to the service proving apparatus 12. When the service request determination unit 113 determines to send the service request, the service request unit 111 sends a service request to the service proving apparatus 12.

The service request determination unit 113 may determine whether the service of the service providing apparatus 12 is essential for the whole system, and may perform the above-mentioned process only when the service is not essential.

The service providing apparatus 12 performs the service in the service providing unit 121 in response to the service request from the service request apparatus 11.

Accordingly, when the service providing apparatus is out of order, the service request apparatus 11 does not send a request to the service providing apparatus 12. Therefore, the service request apparatus 11 can perform a next process. When a response result from the service proving apparatus 12 is necessary for performing the next process, a predetermine value (a value indicating no response, “FFFF”, for example) can be used.

In addition, the technique of this embodiment can solve the problem that the service request apparatus 11 sends the service request repeatedly when the service providing apparatus 12 is in failure.

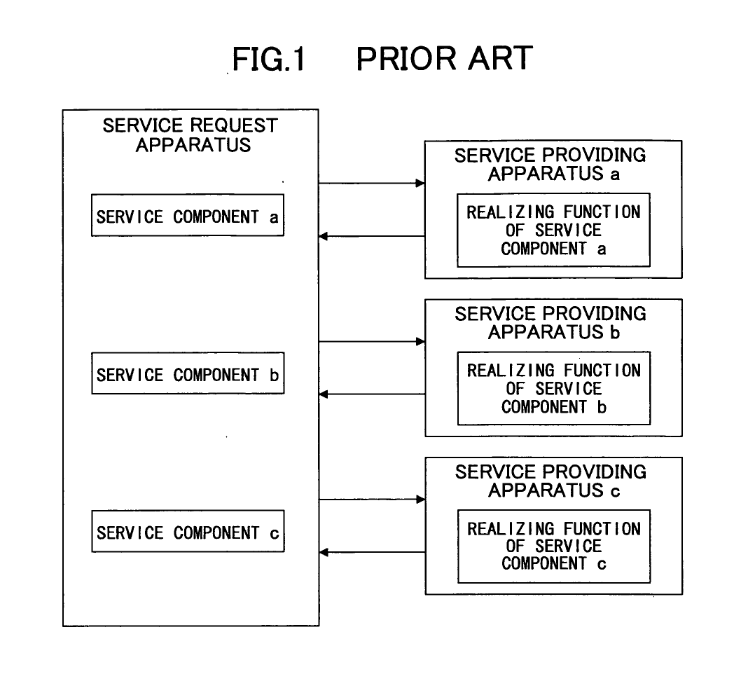

For example, by applying the first embodiment to the service request apparatus shown in FIG. 1, processes for the service providing apparatuses “a” and “c” can be continuously performed even when the service providing apparatus “b” is in failure.

### Second Embodiment

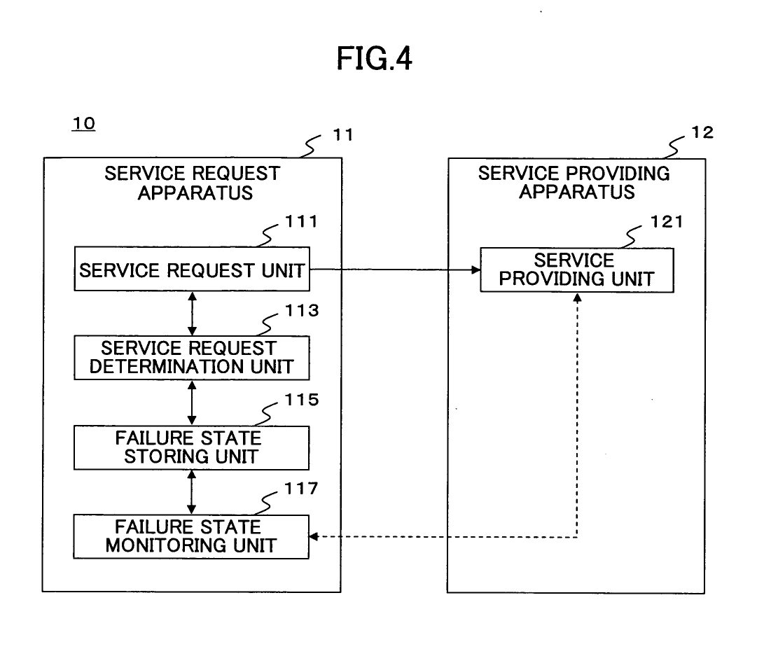

FIG. 4 is a block diagram showing the whole of a system 10 of the second embodiment of the present invention.

The system 10 includes a failure state monitoring unit 117 in addition to the units of the system 10 shown in FIG. 3. Operation other than the failure state monitoring unit 117 is the same as that of the system 10 shown in FIG. 3. The failure state monitoring unit 117 monitors the failure state of the service providing apparatus 12 and stores the failure state of the service providing apparatus 12 into the failure state storing unit 115. The failure state monitoring unit 117 stores the failure state of the service providing apparatus 12 into the failure state storing unit 115 based on: no response for a request to the service providing apparatus 12; an abnormal response from the service providing apparatus 12; no response for a health check signal that is periodically sent; failure notification from another system (monitoring system, etc.); report by a maintenance person; or the like.

By monitoring the failure state as mentioned above so as to keep the failure state of the failure state storing unit 115 to be the newest state, the service request apparatus 11 can send a service request to the service providing apparatus 12 to provide the service when the failure of the service providing apparatus 12 is recovered.

### Third Embodiment

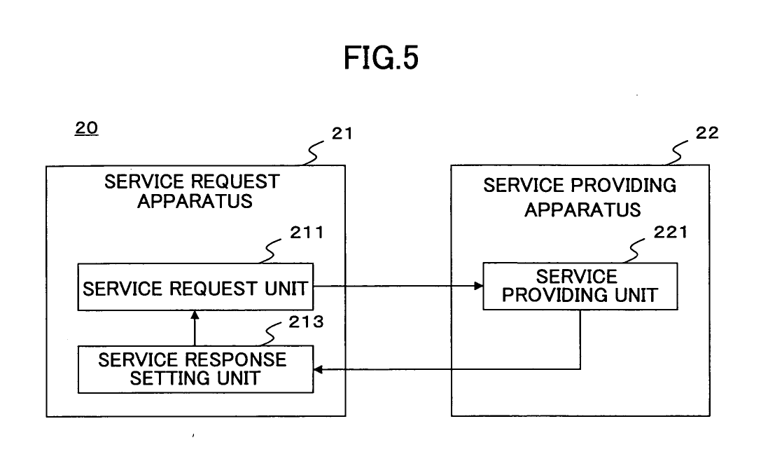

FIG. 5 is a block diagram showing the whole of a system 20 of the third embodiment of the present invention.

The system 20 includes a service request apparatus 21 and a service providing apparatus 22.

The service request apparatus 21 includes a service request unit 211 and a service response setting unit 213. The service request unit 211 sends a service request to the service providing apparatus 22. When the service providing apparatus 22 provides the service by the service providing unit 221 in response to the request and sends a response to the service request apparatus 21, the service request apparatus 21 can perform the next process as usual. However, when the service providing apparatus 22 is in failure, the service request apparatus 21 cannot receive the response from the service providing apparatus 22. When there is no response from the service providing apparatus 22 like this case, the service response setting unit 213 sets a response for the service request sent from the service request unit 211 on behalf of the service providing apparatus 22.

Accordingly, even when the service providing apparatus 22 is in failure, the service request apparatus 21 can perform the next process. In addition, the technique of this embodiment can solve the problem that the service request apparatus 21 sends the service request repeatedly when the service providing apparatus 22 is in failure.

<Application Example to SIP Server>

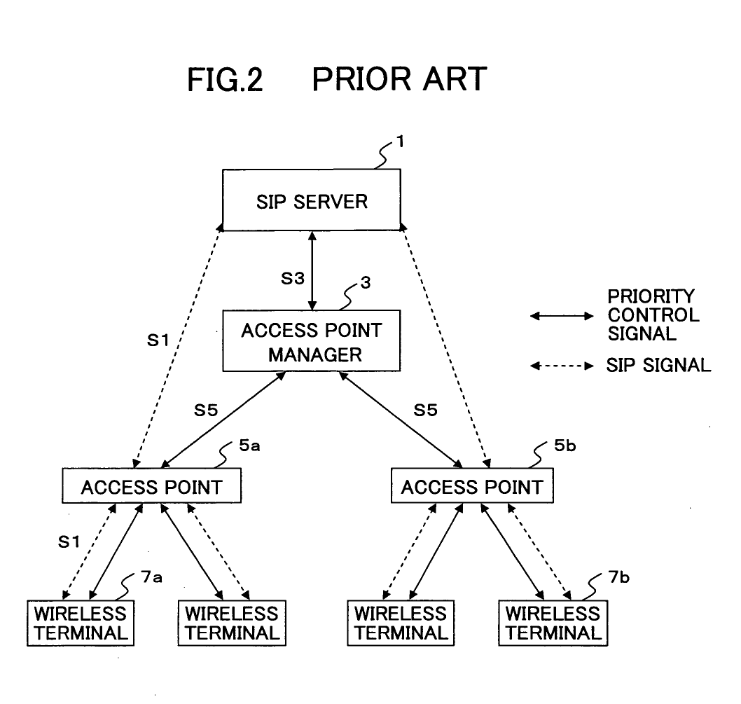

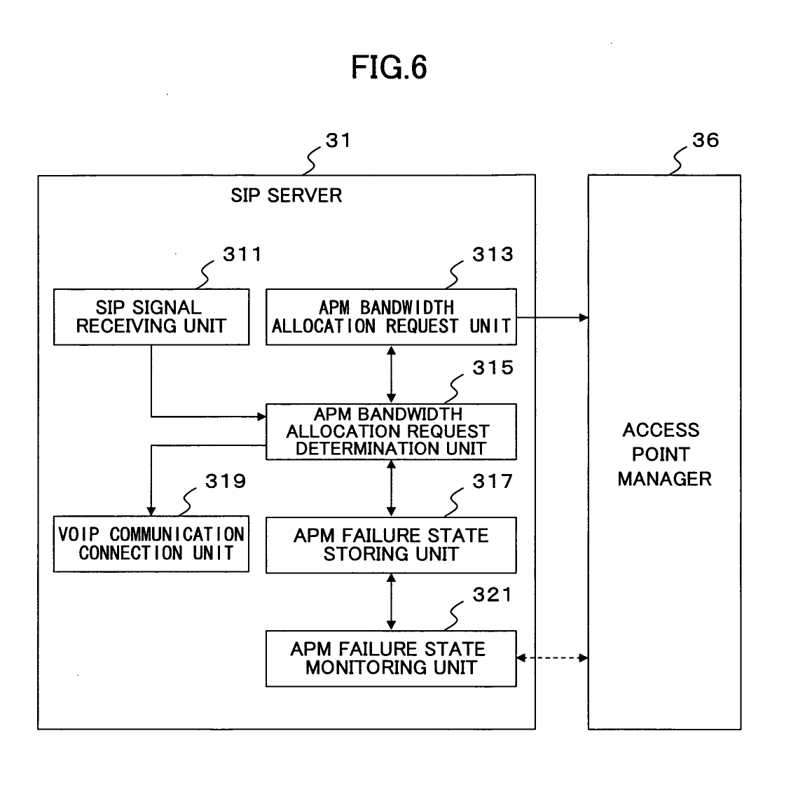

A case for applying the above-mentioned embodiments to the SIP server of the communication system shown in FIG. 2 is described with reference to FIGS. 6-8. As mentioned before, the SIP server establishes a VoIP communication connection between the wireless terminals based on the SIP protocol. The SIP sever sends a request for bandwidth allocation to the access point manager when it becomes necessary to allocate bandwidth between the wireless terminals when receiving an INVITE message, for example. At this time, a scheme is described in the following in which a next process (establishment of VoIP communication connection without bandwidth allocation (without prioritization)) can be performed even when the access point manager is in failure.

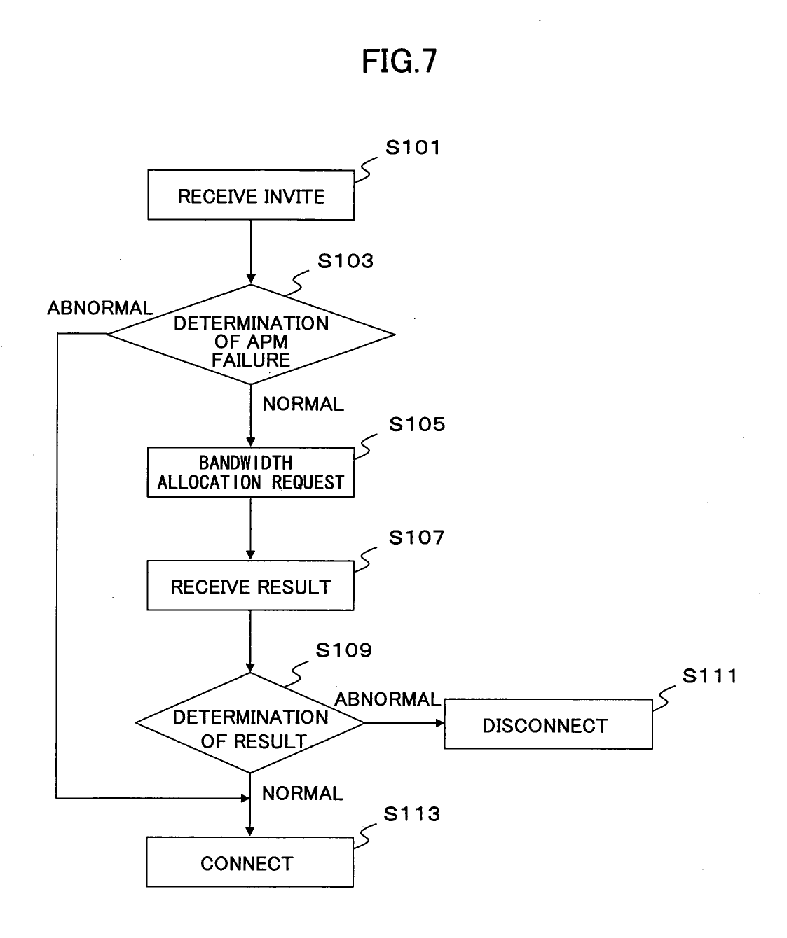

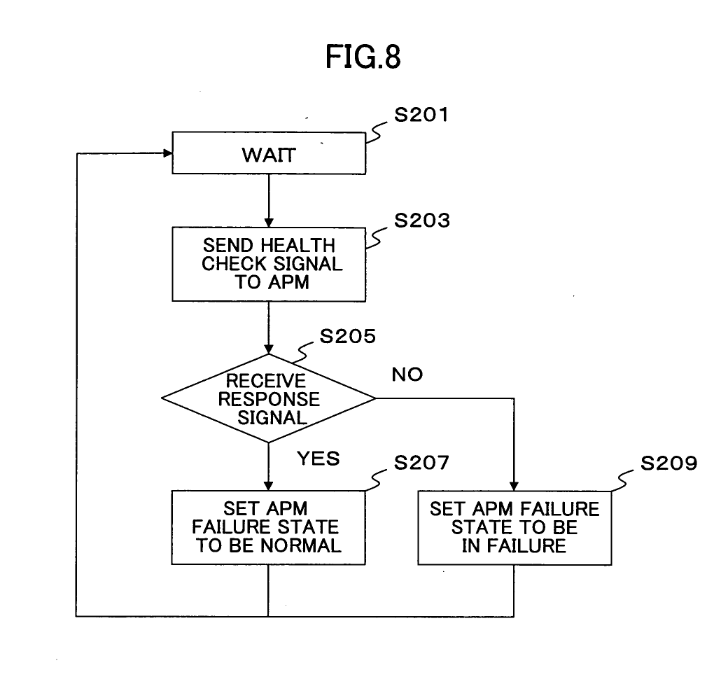

FIG. 6 is a block diagram showing the SIP server 31 and the access point manager 36 to which the embodiment of the present invention is applied. FIG. 7 is a flowchart showing communication connection operation in the SIP server to which the embodiment of the present invention is applied. FIG. 8 is a flowchart showing failure state monitoring operation in the SIP server using the embodiment of the present invention.

The SIP server 31 includes a SIP signal receiving unit 311, an APM (access point manager) bandwidth allocation request unit 313, an APM bandwidth allocation request determination unit 315, an APM failure state storing unit 317, a VoIP communication connection unit 319, and an APM failure state monitoring unit 321.

The SIP signal receiving unit 311 receives a SIP signal such as INVITE and determines whether it is necessary to send a bandwidth allocation request to the access point manager 36 in step 101. When it is necessary to send the bandwidth allocation request, the SIP signal receiving unit 311 refers to the APM bandwidth allocation request determination unit 315 to determine whether to send the bandwidth allocation request to the access point manager 36 in step 103. The APM bandwidth allocation request determination unit 315 refers to the failure state of the access point manager 36 stored in the APM failure state storing unit 317. When the access point manager 36 is not in failure, it is determined to send the bandwidth allocation request to the access point manager 36. In this case, the APM bandwidth allocation request unit 313 sends the bandwidth allocation request to the access point manager 36 in step 105. Then, the access point manager 36 allocates bandwidth between the wireless terminals and sends the result to the SIP server 31 as a response. The SIP server receives the response in step 107. When the response is normal, the VoIP communication connection unit 319 establishes a communication connection between the wireless terminals in step 113. When the response is abnormal, the communication connection between the wireless terminals is not established in step 111.

On the other hand, when the failure state of the access point manager 36 stored in the APM failure state storing unit 317 indicates “failure” in step 103, the APM bandwidth allocation request determination unit 315 determines not to send the bandwidth allocation request to the access point manager 36. Next, the VoIP communication connection unit 319 establishes the communication connection between the wireless terminals in step 113. In this case, although bandwidth allocation is not performed since the bandwidth allocation is not requested to the access point manager 36, the VoIP communication connection can be established.

Accordingly, it can be chosen to prioritize VoIP communication or not according to the failure state of the access point manager. In addition, since any unnecessary request is not sent to the access point manager, delay of processes and a squeeze of process capability due to increase of retransmission signals can be avoided.

The APM failure state monitoring unit 321 periodically monitors the failure state of the access point manager 36. After a predetermined time elapses in step 201, the APM failure state monitoring unit 321 sends a health check signal to the access point manager 36 in step 203. When receiving the response in step 205, the APM failure state monitoring unit 321 sets the failure state of the access point manager stored in the APM failure state storing unit 317 to be normal in step 207. When the response is not received in step 205, the APM failure state monitoring unit 321 sets the failure state of the access point manager stored in the APM failure state storing unit 317 to be in failure in step 209. By performing such processes continuously, the APM failure state monitoring unit 321 periodically updates the failure state of the access point manager.

<Application Example to the Access Point Manager>

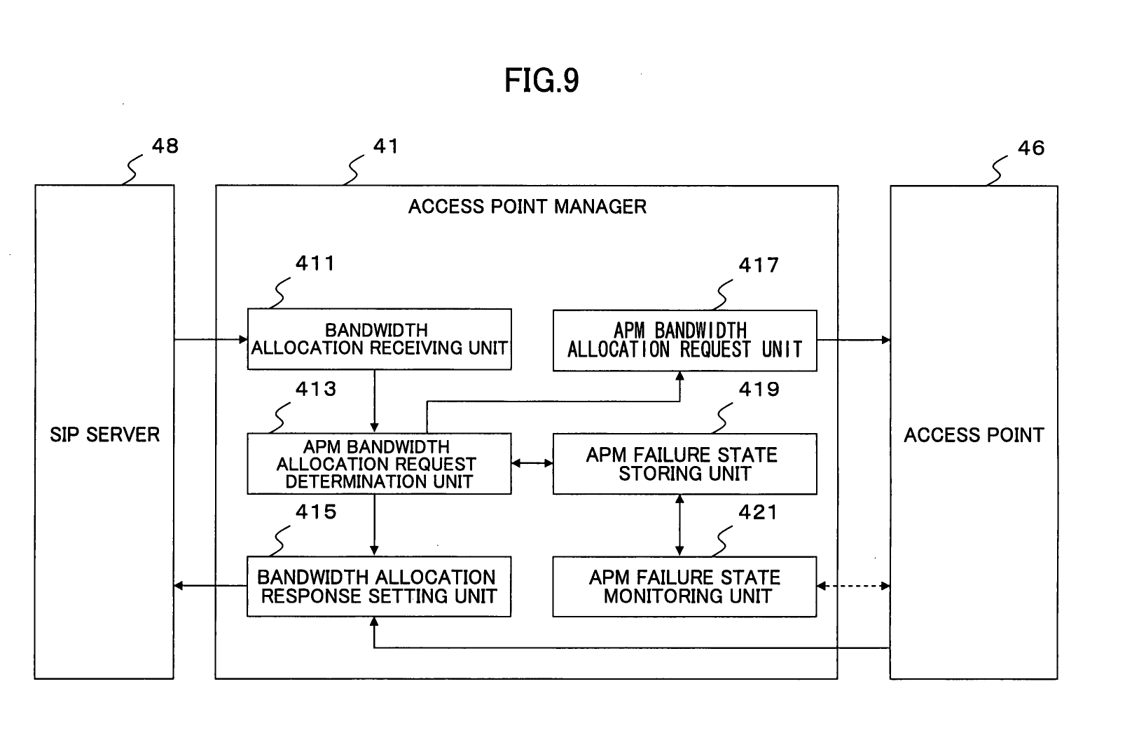

In the following, a case in which the above-mentioned embodiment is applied to the access point manager of the communication system shown in FIG. 2 is described with reference to FIGS. 9-11. As mentioned before, the access point manager sends a request for bandwidth allocation to the access point according to a request for bandwidth allocation from the SIP server. A scheme is described in the following in which the next process (establishment of a VoIP communication connection without bandwidth allocation) can be performed even when the access point is in failure or there is no response from the access point.

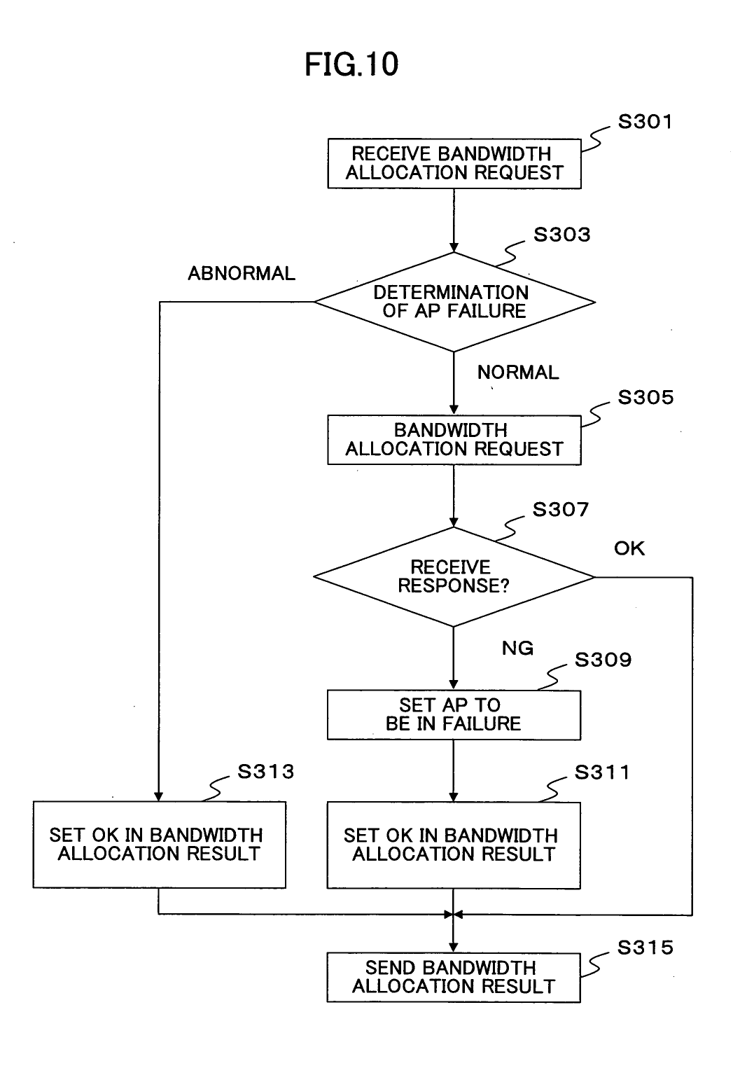

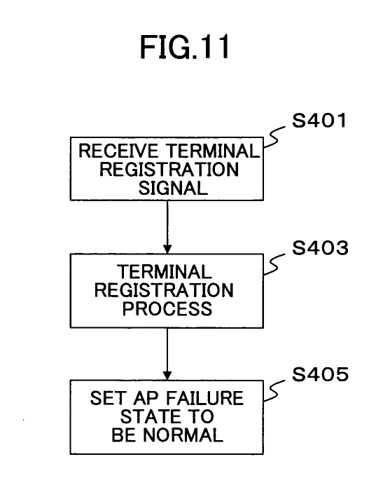

FIG. 9 is a block diagram of the SIP server 48, the access point manager 41 and the access point 46 to which the embodiment of the present invention is applied. FIG. 10 is a flowchart showing bandwidth allocation management operation in the access point manager to which the embodiment of the present invention is applied. FIG. 11 is a flowchart showing failure state monitoring operation in the access point to which the embodiment of the present invention is applied.

The access point manager 41 includes a bandwidth allocation receiving unit 411, an AP (access point) bandwidth allocation request determination unit 413, a bandwidth allocation response setting unit 415, an AP bandwidth allocation request unit 417, an AP failure state storing unit 419 and an AP failure state monitoring unit 421.

The bandwidth allocation receiving unit 411 receives a request for bandwidth allocation from the SIP server 49 in step 301. Before sending the request for bandwidth allocation to the access point, the APM bandwidth allocation request determination unit 413 refers to the failure state of the access point 46 stored in the AP failure state storing unit 419 in step 303. When the access point 46 is not in failure, it is determined to send the request for bandwidth allocation to the access point 46. In this case, the AP bandwidth allocation request unit 417 sends the bandwidth allocation request to the access point 46 in step 305. The access point 46 allocates bandwidth between the wireless terminals, and responds the result to the access point manager 41. When the access point manager 41 normally receives the response in step 307, the bandwidth allocation response setting unit 415 sends the bandwidth allocation result to the SIP server 48 as a response in step 315. As a result, bandwidth allocation is performed so that a VoIP communication connection is established.

On the other hand, when the failure state of the access point 46 stored in the AP failure state storing unit 419 indicates “failure” in step 303, the AP bandwidth allocation request determination unit 413 determines not to request access point 46 to allocate bandwidth. In this case, the bandwidth allocation response setting unit 415 sets OK as the bandwidth allocation result in step 313, and sends a response to the SIP server 48 in step S315. As a result, bandwidth allocation is not performed, but a VoIP communication connection can be established.

In addition, there may be a case in which, although the AP bandwidth allocation request unit 417 sends a bandwidth allocation request to the access point 46 in step 305, the response is not received (step 307). In this case, the AP failure state monitoring unit 421 sets the failure state of the access point in the AP failure state storing unit 419 to be “failure” in step 309. In addition, the bandwidth allocation response setting unit 415 sets OK as the bandwidth allocation result in step 311 and sends a response to the SIP server 48 in step 315. As a result, the bandwidth allocation is not performed, but the VoIP communication connection can be established.

Accordingly, it can be chosen to prioritize VoIP communication or not according to the failure state of the access point. In addition, since unnecessary request is not sent to the access point, delay of processes and a squeeze of process capability due to increase of retransmission signals can be avoided.

The AP failure state monitoring unit 421 periodically monitors the failure state of the access point 46. The access point manager 41 receives a signal such as a terminal registration signal from the access point 46. When receiving such signal in step 401, the access point manager 41 performs terminal registration in step 403, and the AP failure state monitoring unit 421 determines that the access point 46 is normal so as to set the failure state of the access point in the AP failure state storing unit 419 to be normal in step 405. As mentioned before, when there is no response for the bandwidth allocation request from the access point 46, the AP failure state monitoring unit 421 sets the failure state of the access point in the AP failure state storing unit 419 to be in failure in step 309. Accordingly, the AP failure state monitoring unit 421 periodically updates the failure state of the access point. <An Example of Application to the Access Point>

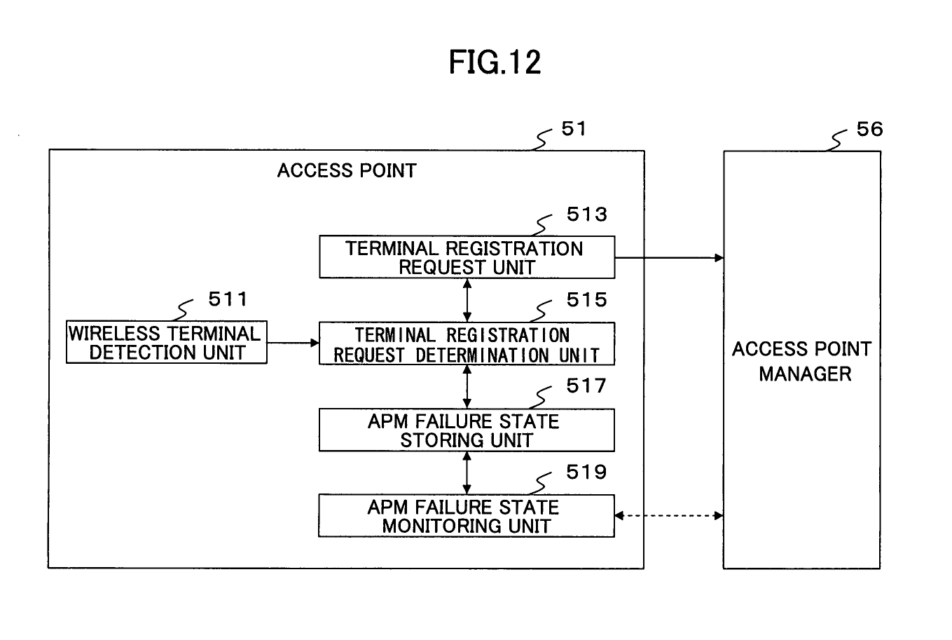

In the following, a case in which the above-mentioned embodiment is applied to the access point of the communication system shown in FIG. 2 is described with reference to FIGS. 12-14. As mentioned before, the access point sends a terminal registration of the wireless terminal to the access point manager. In this case, a scheme is described in which a normal wireless communication function can be provided even when the access point manager is in failure.

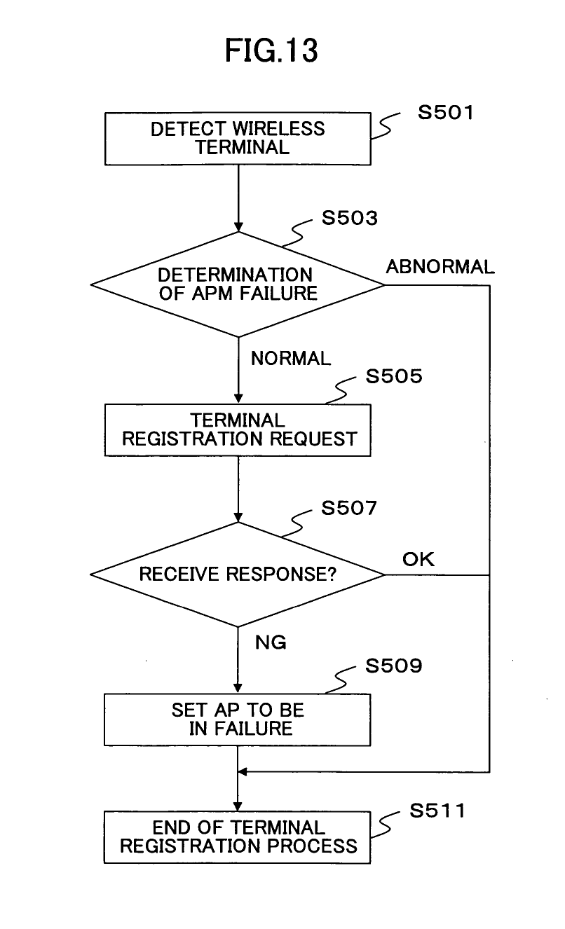

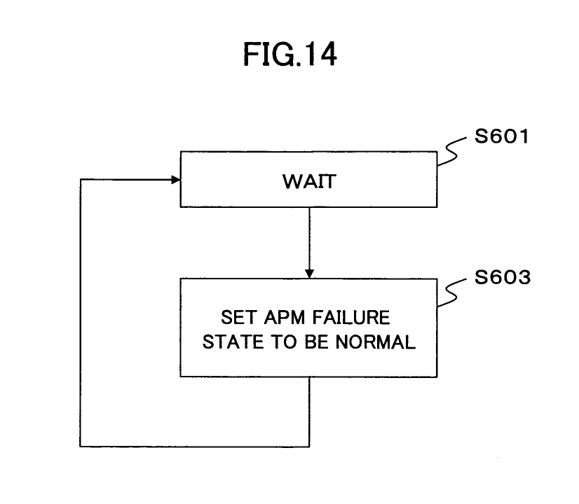

FIG. 12 is a block diagram of the access point 51 and the access point manager 56 to which the embodiment of the present invention is applied. FIG. 13 is a flowchart showing terminal registration operation in the access point to which the embodiment of the present invention is applied. FIG. 14 is a flowchart showing failure state monitoring operation in the access point to which the embodiment of the present invention is applied.

The access point 51 includes a wireless terminal detection unit 511, a terminal registration request unit 513, a terminal registration request determination unit 515, an APM failure state storing unit 517, and an APM failure state monitoring unit 519.

The wireless terminal detection unit 511 detects wireless terminals within a receiving range in step 501.

Before sending the terminal registration of this wireless terminal to the access point manager 56, the terminal registration request determination unit 515 refers to the failure state of the access point manager 56 stored in the APM failure state storing unit 517 in step 503. When the access point manager 56 is not in failure, it is determined to send the terminal registration request to the access point manager 56. In this case, the terminal registration request unit 513 sends a request for terminal registration to the access point manager 56 in step 505. The access point manager 56 performs terminal registration, and sends the result to the access point 51. When the access point 51 receives the response normally in step 507, the terminal registration process ends in step 511.

On the other hand, when the failure state stored in the APM failure state storing unit 517 indicates that the access point manager 56 is in failure in step 503, the terminal registration request determination unit 515 determines not to send the request for terminal registration to the access point manager 56. Then, the terminal registration process ends in step 511.

In addition, there may be a case in which, although the terminal registration request unit 513 sends the request for terminal registration to the access point manager 56 in step 505, it does not receive a response in step 507. In this case, the APM failure state monitoring unit 519 sets the failure state of the access point manager in the APM failure state storing unit 517 to be in failure in step 509, and completes the terminal registration process in step 511.

Accordingly, VoIP communication can be continues without prioritization even when terminal registration is not performed in the access point manager. In addition, since any unnecessary request is not sent to the access point manager, delay of processes and a squeeze of process capability due to increase of retransmission signals can be avoided.

The APM failure state monitoring unit 519 periodically monitors the failure state of the access point manager 56. After a predetermined time elapses in step 601, the APM failure state monitoring unit 519 sets the failure state of the access point manager to be normal in step 603. As described before, when there is no response for the terminal registration request to the access point manager 56, for example, the APM failure state monitoring unit 519 sets the failure state of the access point manager in the APM failure state storing unit 517 to be in failure in step 509. Accordingly, the APM failure state monitoring unit 519 periodically updates the failure state of the access point manager.

By the way, the SIP server can be also referred to as a communication management apparatus, the access point manager can be also referred to as a bandwidth allocation management apparatus, and the access point can be also referred to as a relay apparatus.

The present invention is not limited to the specifically disclosed embodiments, and variations and modifications may be made without departing from the scope of the present invention.

The present application contains subject matter related to Japanese patent application No. 2006-086528, filed in the JPO on Mar. 27, 2006, the entire contents of which are incorporated herein by reference.

What is claimed is:

1. A service request apparatus that is connected to a service providing apparatus, comprising:
a failure state storing unit configured to store a failure state of the service providing apparatus; and
a service request determination unit configured to refer to the failure state storing unit so as to determine not to send a service request to the service providing apparatus when the service providing apparatus is in failure.

2. The service request apparatus as claimed in claim 1, the service request apparatus further comprising:
a failure state monitoring unit configured to monitor a failure state of the service providing apparatus to store the failure state in the failure state storing unit.

3. A service request apparatus that is connected to a service providing apparatus, comprising:
a service request unit configured to send a service request to the service providing apparatus; and
a service response setting unit configured to set a response for the service request in place of the service providing apparatus when there is no response for the service request.

4. A service request process method performed in a service request apparatus that is connected to a service providing apparatus, comprising the steps of:
storing a failure state of the service providing apparatus in the failure state storing unit; and
referring to the failure state storing unit so as to determine not to send a service request to the service providing apparatus when the service providing apparatus is in failure.

5. The service request process method as claimed in claim 4, further comprising the step of:
monitoring a failure state of the service providing apparatus to store the failure state in the failure state storing unit.

6. A method performed in a service request apparatus that is connected to a service providing apparatus, comprising the steps of:
sending a service request to the service providing apparatus; and
setting a response for the service request in place of the service providing apparatus when there is no response for the service request.

7. A communication management apparatus, for establishing a communication connection between wireless terminals, that is connected to a bandwidth allocation management apparatus for managing bandwidth allocation between wireless terminals, comprising:
a failure state storing unit configured to store a failure state of the bandwidth allocation management apparatus;
a bandwidth allocation request determination unit configured to refer to the failure state storing unit so as to determine not to send a bandwidth allocation request to the bandwidth allocation management apparatus when the bandwidth allocation management apparatus is in failure; and
a communication connection unit configured to establish a communication connection between wireless terminals when the bandwidth allocation request determination unit determines not to send the bandwidth allocation request to the bandwidth allocation management apparatus.

8. The communication management apparatus as claimed in claim 7, the communication management apparatus further comprising:
a failure state monitoring unit configured to monitor a failure state of the bandwidth allocation management apparatus to store the failure state in the failure state storing unit.

9. A bandwidth allocation management apparatus for performing bandwidth allocation between wireless terminals for a relay apparatus according to a bandwidth allocation request from a communication management apparatus, comprising:
a failure state storing unit configured to store a failure state of the relay apparatus;
a bandwidth allocation request determination unit configured to refer to the failure state storing unit so as to determine not to send a bandwidth allocation request to the relay apparatus when the relay apparatus is in failure; and
a bandwidth allocation response setting unit configured to send a response for the bandwidth allocation request to the communication management apparatus when the bandwidth allocation request determination unit determines not to send the bandwidth allocation request to the relay apparatus.

10. The bandwidth allocation management apparatus as claimed in claim 9, further comprising:
a bandwidth allocation request unit configured to send the bandwidth allocation request to the relay apparatus when the bandwidth allocation request determination unit determines to send the bandwidth allocation request to the relay apparatus,
wherein the bandwidth allocation response setting unit sends a response for the bandwidth allocation request to the communication management apparatus when there is no response from the bandwidth allocation request from the relay apparatus.

11. The bandwidth allocation management apparatus as claimed in claim 9, further comprising:
a failure state monitoring unit configured to set the failure state in the failure state storing unit to be normal when receiving a terminal registration signal from the relay apparatus.

12. A relay apparatus that is connected to a bandwidth allocation management apparatus, comprising:
a failure state storing unit configured to store a failure state of the bandwidth allocation management apparatus; and
a terminal registration request determination unit configured to refer to the failure state storing unit so as to determine not to send a terminal registration request to the bandwidth allocation management apparatus when the bandwidth allocation management apparatus is in failure.

13. The relay apparatus as claimed in claim 12, further comprising:
a failure state monitoring unit configured to periodically set the failure state in the failure state storing unit to be normal, and set the failure state in the failure state storing unit to be in failure when there is no response for the terminal registration request sent to the bandwidth allocation management apparatus.
